(19) United States
(12) Patent Application Publication
(10) Pub. No.: US 2005/0161381 A1
(43) Pub. Date: Jul. 28, 2005

(54) Tortuous path in diffusion bonded plates for fluid handling

(76) Inventor: Wesley M. Norman, Landenberg, PA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/764,462

(22) Filed: Jan. 27, 2004

(51) Int. Cl. B01D 15/08

(52) U.S. Cl. 210/198.2

(57) ABSTRACT

A method and corresponding system provide a tortuous path, which functions as restrictors or filters, in diffusion bonded plates for fluid handing. Fluid includes gases, liquids and all types of sample fluids. The method constructs various restrictive elements and etches the restrictive elements into one or more substrates. The substrates are then bonded together using diffusion bonding technology to form fluid flow channels with integrated tortuous paths (functioning as restrictors or filters). The method thus provides a restricting or filtering device that is monolithically integrated into a fluid handling system. The filtering device can also be used as a backup to an external filter to prevent contaminating particles from entering delicate mechanisms of the fluid handling system.

### TECHNICAL FIELD

The technical field relates to gas and liquid chromatography systems, and, in particular, to tortuous paths in diffusion bonded plates for fluid handling.

### BACKGROUND

In gas or liquid chromatography fluid (gas or liquid) handling systems, contaminating particles often plug carrier or flow channels. Various restrictors or filters are used to constrict the flow of gas or liquid and to prevent the flow of contaminating particles within the fluid handling systems. The diffusion bonded plate technology used in current fluid handling systems requires the use of expensive pressed-metal restrictors or filters. The restrictors or filters are assembled into a separate device, which is then bonded to a gas or liquid handling plate. This design adds expense and complexity to the fluid handing systems. Another approach to restrict the flow of contaminating particles involves pinching of carrier or flow channels. However, pinching of flow channels can lead to the flow channel being blocked rapidly by the first large particle too large to fit through the restriction. Still another approach uses external filters in-line with valves, detectors, etc. However, the external filters also bring complexity and additional cost to the fluid handling systems.

### SUMMARY

A method for providing a tortuous path in diffusion bonded plates includes constructing restrictive elements with features in various shapes by lithographing an image of the features onto one or more substrates. The method further includes etching the image of the features into the one or more substrates. The one or more substrates are bonded together to form flow channels. The flow channels include an integrated tortuous flow path that functions as integrated filters.

A substrate having a tortuous flow path for fluid handling includes restrictive elements with features of random characters. An image of the features are lithographed onto one or more substrates and etched into the one or more substrates. The one or more substrates are bonded together to form flow channels. The tortuous flow path formed within the flow channels functions as integrated restrictors.

A system for providing a tortuous path in diffusion bonded plates includes one or more substrates bonded together to form flow channels. The system further includes an integrated tortuous flow path formed within the flow channels by lithographing an image of features onto the one or more substrates and etching the image of the features into the one or more substrates. The integrated tortuous flow path functions as integrated filters.

### DESCRIPTION OF THE DRAWINGS

The preferred embodiments of a method and system for providing a tortuous path in diffusion bonded plates will be described in detail with reference to the following figures, in which like numerals refer to like elements, and wherein:

FIG. 1 illustrates an embodiment of an exemplary fluid handling system with an integrated tortuous flow path that functions as restrictors or filters;

FIGS. 2-5 illustrate exemplary features that form the tortuous flow path of FIG. 1; and

FIG. 6 is a flow chart illustrating an exemplary method for providing a tortuous path in diffusion bonded plates.

### DETAILED DESCRIPTION

A method and corresponding system provide a tortuous path, which functions as restrictors or filters, in diffusion bonded plates for fluid handing. Fluids include gases, liquids and all types of sample fluids. The method constructs various restrictive elements and etches the restrictive elements into one or more substrates. The substrates are then bonded together using diffusion bonding technology to form fluid flow channels with integrated tortuous paths (functioning as restrictors or filters). The method thus provides a restricting or filtering device that is monolithically integrated into a fluid handling system. The filtering device can also be used as a backup to an external filter to prevent contaminating particles from entering delicate mechanisms of the fluid handling system.

Fluid handling systems are well known in the art. For example, U.S. Pat. No. 5,888,390 to Craig, which is incorporated herein by reference, discloses a multilayer integrated assembly for effecting fluid handling functions. Craig's integrated assembly includes complementary microstructures formed by an etching process in a planar foldable substrate. The substrate may be a metal, ceramic, or polymer plate substrate. The complementary microstructures may be superimposed in a controlled manner by operation of micro-alignment means also formed in the foldable substrate by an etching process. Microstructures include carrier or flow channels that may be superimposed to form fluid conduits, apertures, conduit apertures, sample processing compartments, and the like. The resulting integrated assembly may be hermetically sealed and bonded together using diffusion bonding, and subsequently operated to implement fluid-handling functions. Diffusion bonding is a technique that involves solid-state movement of atoms and grain growth across a joint interface. Diffusion bonding provides bonded areas that are practically indistinguishable from the adjacent parent metal even on close metallurgical examination.

As noted above, contaminating particles may plug fluid carrier or flow channels in fluid handling systems. Various restrictors or filters may be used to constrict the flow of gas or liquid and to prevent the flow of contaminating particles from going downstream within the fluid handling systems. The method for providing a tortuous path constructs restrictive elements with various features and etches the features into the substrates to form integrated restrictors or filters in the fluid carrier or flow channels. The features can have either regular or random character or a combination of both characteristics.

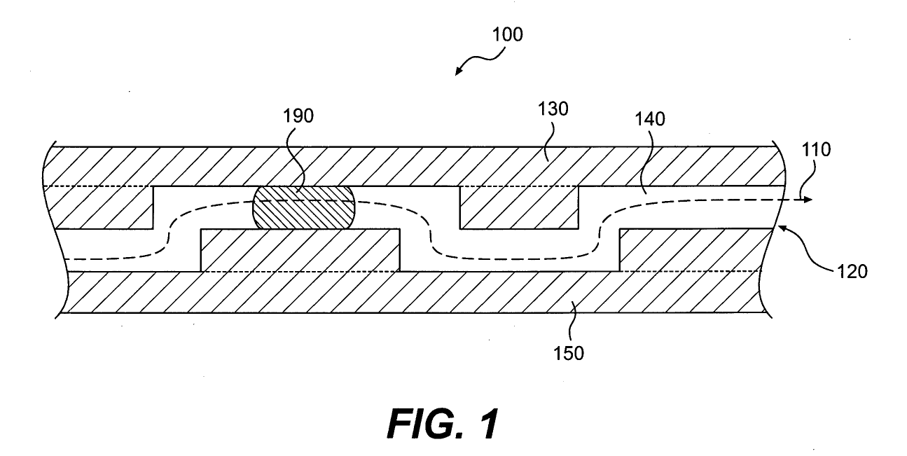

FIG. 1 illustrates an embodiment of an exemplary fluid handling system 100 with an integrated tortuous path functioning as restrictors or filters. The fluid handling system 100 has two substrates 130, 150, which are bonded together using diffusion bonding technology. A fluid carrier or flow channel 140 is formed between two bond lines 120. The channels 140 may be formed in a metal, ceramic, or polymer plate substrate 130, 150, and may be etched in a large variety of configurations, such as in a straight, serpentine, spiral, or any tortuous path desired. The channels 140 may also be formed in a wide variety of channel geometries including semi-circular, rectangular, rhomboid, and the like, and the channels 140 may be formed in a wide range of aspect ratios. The channel 140 shown in FIG. 1 has a non-linear configuration.

The fluid carrier or flow channel 140 forms a fluid flow path 110. The fluid flow path 110 may be made tortuous (tortuous flow path) and may function as a restrictor or filter 190 in the fluid carrier or flow channel 140. The tortuous flow path 110 constricts the flow of contaminating particles in the fluid handling system 100. The non-linear configuration of the channel 140 (as shown in FIG. 1) allows a small amount of restriction in the fluid flow path 110 by adding additional length to the fluid flow path 110.

The tortuous flow path 110 may be formed by lithographing an image of certain regular or random features onto one or more substrates 130, 150, i.e., diffusion bonded plates. The substrates may then be bonded together hermetically to form the fluid carrier or flow channel 140 with integrated tortuous flow path 110. The integrated tortuous flow path 110 functions as integrated restrictors or filters in the fluid carrier or flow channels. These filters can remove contaminating particles without causing residue to remain in the fluid handling system. The restrictive elements may also function as a restrictor and form a restrictive path in the fluid carrier or flow channels.

The regular or random features used to form the tortuous flow path 110 may be defined to suit individual gas or liquid chromatography applications. For example, for applications that require maximum restriction, the features forming the tortuous flow path 110 may be regular features with cross-section shapes of circles or polygons in the same or various sizes. These features may be imprinted symmetrically or asymmetrically on mating substrate surfaces of a pneumatic assembly to reach the desired level of restriction or filtering.

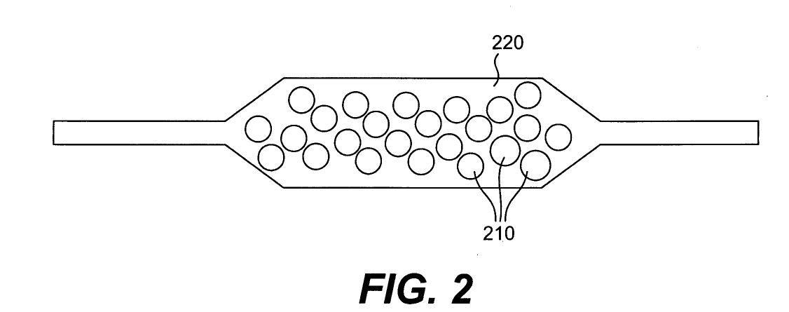

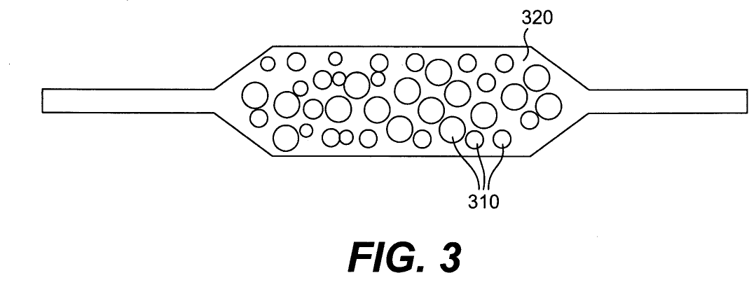

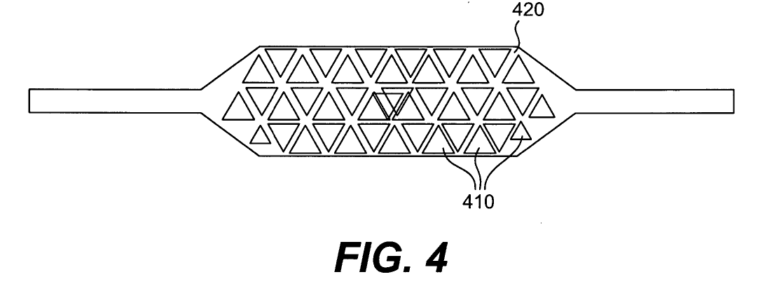

FIGS. 2-5 illustrate exemplary features that form the tortuous flow path 110. FIG. 2 shows exemplary features with regular circles of the same size 210, which is analogous in three dimensions to a tube filled with homogenous size beads. FIG. 3 shows exemplary features with regular circles of various sizes 220, which may be a mixture of small beads and large beads. FIG. 4 shows exemplary features with regular polygons in various sizes 230, which is analogous in three dimension to a tube filled with pyramid shaped blocks.

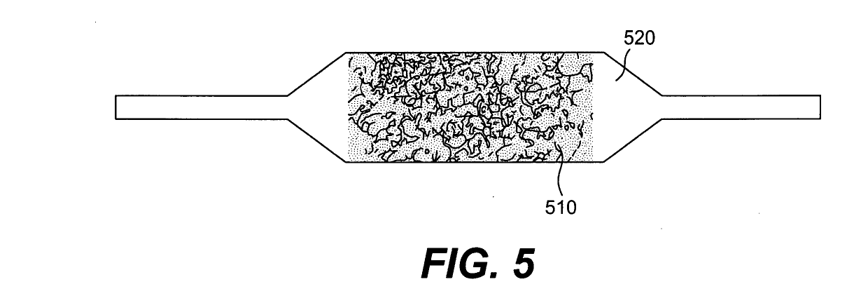

The features forming the tortuous flow path 110 may also be random characters, such as closely packed granules of sand, or an image or simulation of a frit or foam structure with random characters. FIG. 5 illustrates exemplary features with random characters, which resemble an image or simulation of a sponge.

The method for providing a tortuous path lithographs the image or simulation of a structure, for example, a sponge or fine natural frits, and etches the image into the substrate 130, 150. Etching is a preferred method for forming surface features in a wide variety of geometries, and includes such processes as common photolithography. Surface features may be formed by imaging a lithographic mask onto a suitable substrate and then etching the substrate in areas that are unprotected by the lithographic mask. Such masks may define all of the etched features for a selected area of the substrate, for example, and the pattern may encompass multiple pairs of component sections to be created on the substrate, each of which feature complementary sets of microstructures. The method etches the image into the substrate 130, 150 by impressing the image onto a mask that is used to etch the substrate 130, 150.

Because of the randomness of the natural artifact or the simulated natural structure, the tortuous flow path 110 formed by the etching can collect the random character of the natural structure, such as a sponge or fine natural frits. The tortuous flow path 110, functioning as integrated restrictors or filters, constrict the flow of contaminating particles without immediate degradation of flow performance.

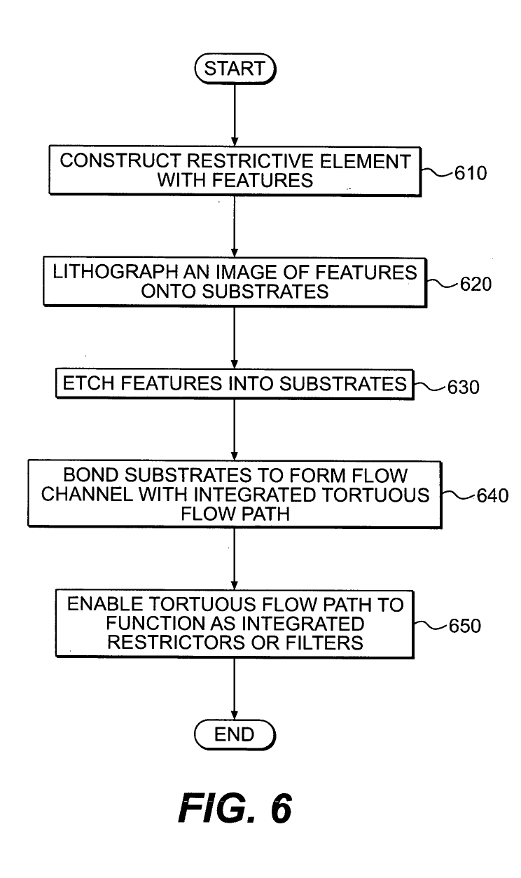

FIG. 6 is a flow chart illustrating an exemplary method for providing a tortuous path in diffusion bonded plates. The method constructs restrictive elements with various features (block 610) by lithographing an image or simulation of the features into one or more substrates 130, 150 (block 620). The method then etches the features into substrates 130, 150 by impressing the image onto a mask that is used to etch the substrate 130, 150 (block 630). The substrates 130, 150 are then bonded together using infusion bonding technology to form fluid carrier or flow channels 140 with integrated tortuous flow path 110 (block 640). The tortuous flow path 110 functions as restrictors or filters 190 to constrict contaminating particles in the fluid handling systems. With integrated restrictors or filters 190, the method provides optimal hermetic sealing and cleanliness by minimizing openings and junctions. The method also minimizes the number of components and the interconnections normally used in complex plumbing solutions.

While the method and system for providing a tortuous path in diffusion bonded plates have been described in connection with an exemplary embodiment, those skilled in the art will understand that many modifications in light of these teachings are possible, and this application is intended to cover variations thereof.

1. A method for providing a tortuous path in diffusion bonded plates, comprising:
constructing restrictive elements with features in various shapes by lithographing an image of the features onto one or more substrates;
etching the image of the features into the one or more substrates; and
bonding the one or more substrates to form flow channels, whereby the flow channels include an integrated tortuous flow path functioning as integrated filters.

2. The method of claim 1, wherein the constructing step includes constructing the restrictive elements with features having random characteristics.

3. The method of claim 1, wherein the constructing step includes constructing the restrictive elements with cross-section shapes of circles.

4. The method of claim 1, wherein the constructing step includes constructing the restrictive elements with cross-section shapes of polygons.

5. The method of claim 1, wherein the constructing step includes constructing the restrictive elements using an image of a frit structure.

6. The method of claim 1, wherein the constructing step includes constructing the restrictive elements using an image of a foam structure.

7. The method of claim 1, wherein the constructing step includes constructing the restrictive elements using a simulated image of a foam structure.

8. The method of claim 1, wherein the flow channels have non-linear configurations to add length of the integrated tortuous flow path.

9. The method of claim 1, wherein the bonding step includes bonding the one or more substrates using diffusion bonding technology.

10. The method of claim 1, wherein the lithographing step includes lithographing the image of the features symmetrically on mating substrates.

11. The method of claim 1, wherein the lithographing step includes lithographing the image of the features asymmetrically on mating substrates.

12. A substrate having a tortuous flow path for fluid handling, comprising:
restrictive elements with features of random characters, an image of the features being lithographed onto one or more substrates and etched into the one or more substrates, wherein the one or more substrates are bonded together to form flow channels; and
an integrated tortuous flow path formed within the flow channels and functioning as integrated restrictors.

13. The substrate of claim 12, wherein the restrictive elements are constructed using an image of a frit structure.

14. The substrate of claim 12, wherein the restrictive elements are constructed using an image of a foam structure.

15. The substrate of claim 12, wherein the restrictive elements are constructed using a simulated image of a foam structure.

16. The substrate of claim 12, wherein the flow channels have non-linear configurations to add length of the integrated tortuous flow path.

17. The substrate of claim 12, wherein the integrated tortuous flow path functions as integrated filters.

18. A system for providing a tortuous path in diffusion bonded plates, comprising:
one or more substrates bonded together to form flow channels; and
an integrated tortuous flow path formed within the flow channels by lithographing an image of features in various shapes onto the one or more substrates and etching the image of the features into the one or more substrates, the integrated tortuous flow path functioning as integrated filters.

19. The system of claim 18, wherein the features having random characters.

20. The system of claim 18, wherein the integrated tortuous flow path is formed by lithographing an image of a foam structure onto the one or more substrates.
